(19) United States
(12) Patent Application Publication
(10) Pub. No.: US 2009/0198621 A1
(43) Pub. Date: Aug. 6, 2009

(54) Energy price protection system and method

(76) Inventors: Lance W. Schneier, Dublin, OH (US); Thomas S. Reichelderfer, Upper Arlington, OH (US); Sudheer Pimputkar, Worthington, OH (US)

Correspondence Address: Gary P. Topolosky, 4031 Brownsville Road, Pittsburgh, PA, 15227-3419, US

(21) Appl. No.: 12/322,577

(22) Filed: Feb. 4, 2009

Related U.S. Application Data
(60) Provisional application No. 61/063,532, filed on Feb. 4, 2008.

(51) Int. Cl. G06Q 30/00; G06Q 20/00; G06Q 50/00; G06Q 40/00

(52) U.S. Cl. 705/80; 705/412; 705/40; 705/37

(57) ABSTRACT

Protection is provided against increases in the price of energy. As an example, the protection may be provided for an agreed in advance quantity of energy and/or for an agreed in advance duration.

### CROSS-REFERENCE TO RELATED APPLICATIONS

This application claims priority to U.S. Provisional Application Ser. No. 61/063,532, filed on Feb. 4, 2008, the disclosure of which is fully incorporated by reference herein.

### FIELD OF THE INVENTION

The present invention relates to consumer price protection for different types of energy purchased at retail. More particularly, this invention relates to a system and method for subscribing consumers to protect them from price increases in the energy form or forms they purchase on a regular or periodic basis.

### BACKGROUND OF THE INVENTION

In recent years, fuel prices have tended to fluctuate unpredictably, usually due to factors outside the control of consumers. International oil prices can vary daily, and often widely, with current Middle East political conditions and the possibility of further conflict expansion. The refining of oil and oil products may be shut down, or at least curtailed, when hurricanes and other violent weather threaten offshore facilities.

Consumers of various fuel products may desire a system that protects them against energy price volatility. Such a system would provide an energy price protection plan that addresses fluctuations over time. Energy consumers would be able to safeguard themselves by subscribing to an energy protection plan that cushions against unpredictable price swings. This plan would be especially desirable if it rewarded subscribers with credits or refunds if the price increase for a prescribed time period was greater than expected.

Preferably, any such consumer price protection program should extend to multiple, or numerous, energy types and not just gasoline consumed by most automobiles today. Several recent references propose incentivizing automobile sales by including therewith a fuel price protection method. See, for example, Miller et al. U.S. Published Patent Application Serial No. 20070038553 and Hadjukiewicz et al. U.S. Pat. No. 6,980,960. This invention differs from the aforementioned prior art in the following critical ways:
The prior art systems are not stand-alone programs; they are concomitant upon the purchase or acquisition of another product.
The intent of the Miller et al. published application is to boost sales of a product (e.g., automobiles). It is not intended to protect against energy price increases. As such, the consumer has no discretion in extending the period of price stability, nor is the consumer able to access the price stability without purchase of the product.
Both prior art systems primarily focused on, and restricted themselves to, one fuel—gasoline.
The present invention clearly establishes objective, third-party price references whereby the consumer can assure himself of the transparency and fairness of the pricing calculations

### SUMMARY OF THE INVENTION

In accordance with an aspect of the present invention, protection is provided against increases in the price of energy. As an example, the protection may be provided for a specified quantity of energy and for a specified duration.

Another aspect relates to a method of providing quantitative value to a consumer in a consumer transaction, including providing energy price protection for a quantity of energy over a time period, including providing payment to the consumer based on the difference between a first value of an established energy price and a second value related to the actual price of the energy quantity if the second value exceeds the first value.

Another aspect relates to a method of providing energy price protection, including acquiring financial instruments to acquire physical or derivative energy products at future times, based, at least in part, on:
the cost to acquire such financial instruments,
the anticipated value of such financial instruments during a prescribed time frame,
determining a commercially valuable price at which to sell energy price protection for a quantity of energy, and
providing payment to a consumer based on the difference between an established energy price and the actual price of the energy quantity, if the second value exceeds the first value.

Another aspect relates to a method of providing price protection for energy, including guaranteeing that the effective cost (cost to the subscription/purchaser) per unit of energy, up to a limiting quantity, over a given time period will not exceed a predetermined price.

These and other objects, features, advantages and functions of the invention will become more apparent as the following description proceeds.

It will be appreciated that although the invention is described with respect to one or more embodiments, the scope of the invention is limited only by the claims and equivalents thereof. It also will be appreciated that although the invention may be described with respect to several embodiments, features of a given embodiment also may be used with one or more other embodiments.

To the accomplishment of the foregoing and related ends, the invention comprises a system and method of providing quantitative value to a consumer in a consumer transaction. The system and method comprises providing energy price protection for a quantity of energy purchased over a time period. The system and method includes providing payment to the consumer based on the difference between a first value of an established energy price and a second value related to the actual price of the energy quantity if the second value exceeds the first value.

### BRIEF DESCRIPTION OF THE DRAWINGS

Further features, objects and advantages will become clearer when reviewing the detailed description of preferred embodiments made with reference to the accompanying drawings in which:

FIG. 1 is a block diagram schematically illustrating an energy price protection (EPP) system and method according to one embodiment of this invention;

FIG. 2 is a block diagram schematically illustrating one embodiment of consumer enrollment component according to this invention;

FIG. 3 is a block diagram schematically illustrating one embodiment of reconciliation component according to this invention; and

FIG. 4 is a schematic illustration of seven representative inputs that may be factored into one embodiment of energy price protection system according to this invention.

### DETAILED DESCRIPTION OF PREFERRED EMBODIMENTS

In the description that follows, terms such as fuel, gasoline, natural gas, diesel fuel, heating oil, propane, etc., may be used. Generally, these terms are used equivalently and interchangeably to represent a generic energy type unless otherwise specifically indicated or indicated by context. Also, terms such as purchase, sale, lease, rent, etc., may be used equivalently and interchangeably unless otherwise specifically indicated or indicated by context.

Energy Price Protection (EPP) is a unique and innovative product concept that allows residential and commercial users of fuel or energy (including natural gas, electricity, gasoline, propane and fuel oil) to protect them against increasing energy costs. A consumer signs up for a protection plan that consists of a protection price, a protection amount and a protection term. Each subscribing consumer will be able to choose one or more types of energy to protect.

The energy protection price is selected using data collected and maintained by EPP. This reference data is based upon standard, objective market prices which are geographic specific and collected from various reporting services, commodity exchanges and/or administrative agencies which could include the Energy Information Administration and the Oil Price Information Service. Such market prices will act as a reference for what the consumer will actually pay for a given type of energy. The methodology for establishing a transparent, third-party generated, objective price reference is an integral and unique part of the current invention.

In return for providing the protection plan, consumers will pay EPP a one-time service fee for each contract term. The amount of the fee will be determined by the specifics of the protection plan, i.e. protection price, protection amount, protection term. Consumer enrollments will primarily occur through a web-based portal with payment being made via a credit/debit card and/or with an electronic funds transfer (EFT)/automated clearing house (ACH) type transactions.

The basics for protection by the system and method of this invention are as follows:
If during the protection term, the reference market price for a given energy type averaged over a specified period, e.g., one month, exceeds the protection price, the customer is eligible for a refund or EPP credit.
The EPP credit shall equal the difference between the average market reference price and the consumer's protection price multiplied by a contracted consumption amount agreed to between the consumer and the EPP provider.
EPP credits will be calculated at specified intervals, stated in the contract, and, if desired, credited back to the consumer using the same method for paying the initial service/subscription fee.

### Proprietary Web-Based Platform

EPP is developing a fully-functional, scalable e-commerce platform that allows consumers to: (1) determine which protection plan fits their needs; (2) enroll in the plan(s); (3) pay online; (4) monitor the reconciliation of their plan(s) versus the specific market reference price(s); (5) receive credits; and (6) renew once their protection term(s) has expired.

The process for enrolling (or subscribing) is simple and straightforward. Preferably, initial enrollment should not take more than twenty minutes. EPP will provide various charts and tools to assist consumers in making the appropriate choice for their specific energy needs.

### Pricing and Risk Management Infrastructure

EPP utilizes a number of proprietary pricing and risk management tools to price the various protection plans. A main goal of this system and method is to mitigate exposure to market fluctuations, thereby facilitating planning and budgeting by the consumer. Each protection plan is individually priced based on:
1. The Consumer's Geographic Location
2. The Energy Type(s) selected by the Consumer
3. A Market Reference Price for each Energy Type Chosen
4. A Protection Price
5. A Protection Amount
6. An Initial Protection Term (renewable and extendible); and
7. The Initial Date of Consumer Enrollment

EPP will aggregate energy protection plans with similar characteristics and then purchase energy products using various hedging tools from the financial marketplace to ensure that EPP's subscribing customers receive the value promised.

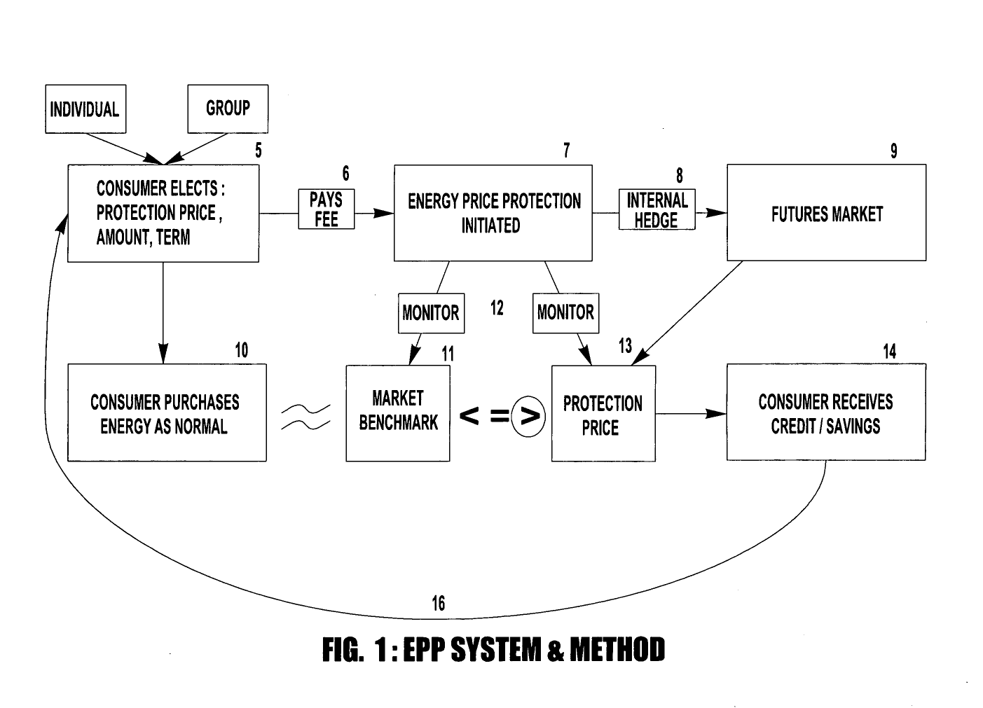

In the accompanying drawings, like referenced numerals designate like parts in the several figures. Referring now to FIG. 1, there is shown a block diagram of a system or method according to one embodiment of this invention. Therein, the EPP system is includes at least one Provider 7 who provides energy price protection to a subscribing Consumer 5. Energy price protection may be provided in one or more ways. For example, Provider 7 may provide protection directly to Consumer 5 enrolled in the protection plan. Alternately, Provider 7 may provide indirect price protection, most likely, to a group of common consumers (by their respective enrollments in a purchasing group, association, subscriber/membership base, franchisee(s), etc). Payment for enrollment in this energy price protection system may be provided by credit card, debit card or ACH transaction.

Provider 7 provides price protection assurances to Consumer 5 that over a given period of time (sometimes referred to as a limited time period or term), Consumer 5 can buy one or more energy types for his residence and/or business at a price that does not exceed a given market reference price (sometimes referred to as a predetermined price, prescribed pricing or the like). The average market reference price may be determined using an independent indicator of the price, such as the New York Mercantile Exchange. The average market reference price may also be determined with respect to geographical considerations, e.g., within a city, county, state or some other region where Consumer 5 resides.

The average market reference price may include taxes and/or other add-ons in addition to the price of the fuel. The quantity of energy for which price is protected over time may also be predetermined. The duration that price protection may be provided may be a number of months, e.g., from six months to about three years (sometimes referred to as the protection term or simply “term”). It will be appreciated that the values expressed are exemplary only and may be more or less than those expressed. For example, the time period may be more or less than one month; the predetermined protection price something other than average price per month; and the protection term more or less than six to thirty-six months (six months to three years).

The EPP Provider 7 will, most likely, perform some energy price hedging during a given energy consumption period. Hedging allows Provider 7 to supply energy price protection even though actual prices for oil, electricity, natural gas, etc. may vary over time. Examples of hedges include one or more of acquiring by purchase or otherwise options (e.g., calls, puts, etc.), futures, derivatives, combinations of the foregoing and/or other instruments or mechanisms that may be purchased and sold to provide funding to pay Provider 7 to fulfill the obligations promised to Consumer 5.

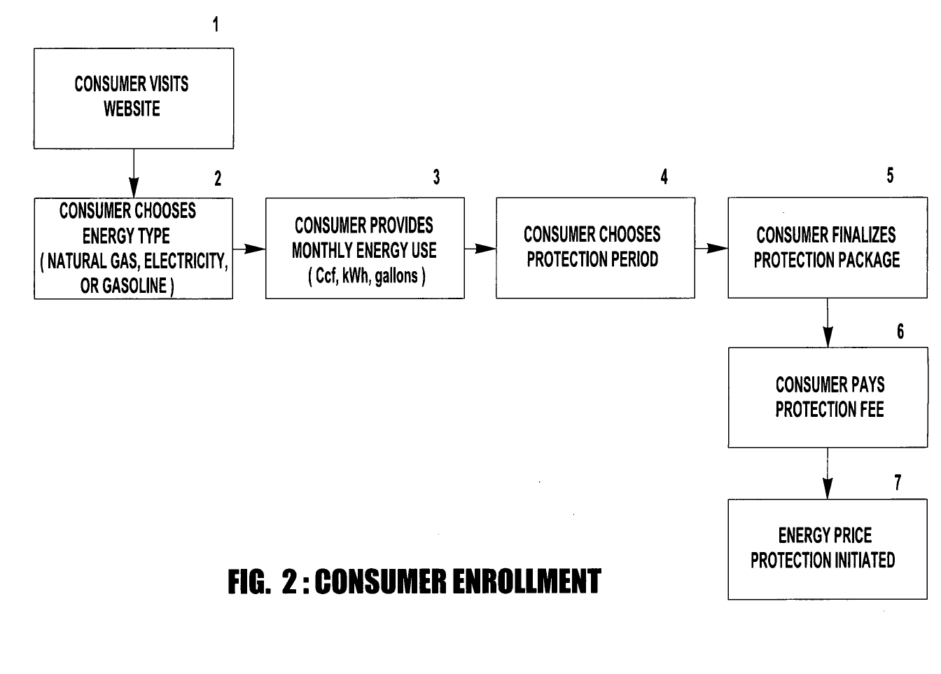

Turning now to FIG. 2, there is shown a block diagram illustrating how a Consumer 5 enrolls in one embodiment of system according to this invention. Particularly, at Block 2, Consumer 5 may select from one of several offered energy price protection plans. For a given energy type and/or geographic location, it may be the case that only one variety of EPP will be offered . . . possibly for a limited time until other providers and/or energy delivery means become available. At Blocks 2 through 4, the size, timing and cost of the EPP that the Consumer selects are calculated. Note also that in Block 3, the Consumer provides monthly energy use (kWh, gallons, Ccf). A preliminary price or Fee 6 to charge Consumer 5 may be determined by this calculation.

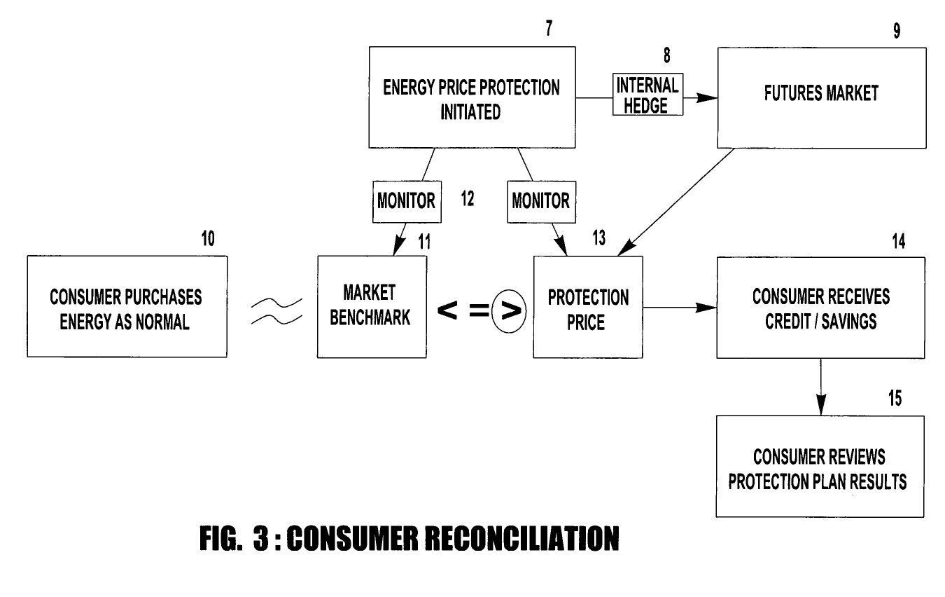

Thereafter, the risk of price increases is converted into terms that can be hedged in the financial market (See especially, Block 8 of FIG. 1). Examples of such hedge instruments include options, futures, derivatives, combinations and/or other instruments. As an example, an option to purchase a quantity of natural gas or crude oil at a given price may be purchased. If the price of fuel increases, the option increases in value and may provide some or all of the funds or other value needed to issue Consumer 5 a refund/credit per FIG. 3.

Turning now to FIG. 3, there is shown a block diagram illustrating one representative means for a Consumer 5 to redeem or reconcile past credits/refunds earned in the EPP. Specifically, at Block 14, credits are returned to the Consumer based on the Monitoring 12 and calculating carried out earlier. Preferably, the credit payment takes the same form of payment by the Consumer in paying his/her initial subscription or service Fee (Block 6 in FIGS. 1 and 2).

At Block 15 of FIG. 3, the calculated changes and/or other account information may be posted for review by the subscribing Consumer. Security will be provided so that the Consumer may review only his or her own records. Loop line 16 in FIG. 1 depicts the possibility of repeating the above described steps for also meeting the same Consumer's business energy needs.

The various methodologies described herein may be implemented using financial instruments, such as a swap, call option, put option, or the like. As is well known, a swap is a derivative, where two counter parties exchange one stream of cash flows against another stream. The cash flows are calculated over a notional principal amount. A call option provides the right but not the obligation to buy at a specified price. A put option provides the right but not the obligation to sell at a specified price. The call option and/or put option each can have an expiration date in which they are lost if not executed prior to expiration. Preferably, the call option is based on the average price each day over the period of the agreement. The particular options that may be implemented for each of the price protection methodologies are described in more detail below.

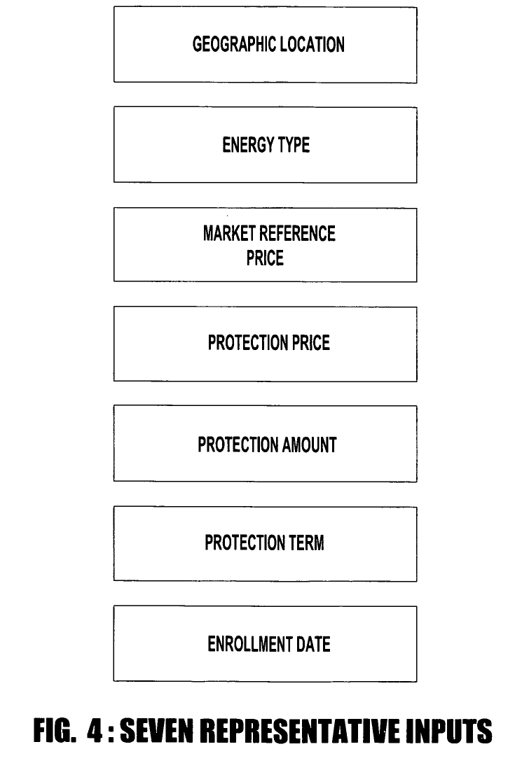

In accompanying FIG. 4, there is shown, in separate blocks, seven representative inputs for one embodiment of system and method according to this invention. Specifically, they include: Geographic Location; Energy Type; Market Reference Price; Protection Price; Protection Amount; Protection Term and Enrollment Date. Still others may be added as this system and method further evolves.

### EXAMPLES

If the average reference price of fuel at the time of the agreement is $3.00 per gallon and the Consumer elects to purchase an energy protection plan at the protection price of $3.20 per gallon, then a call option is placed at $3.20 per gallon. If the average reference price of fuel prices increases above $3.20 per gallon, then the option protects the Provider from the price increase. The difference between the protection level ($3.20 per gallon) and the average market reference price is then calculated and multiplied by the agreed to monthly protection amount with the resulting dollar amount credited back to the Consumer.

Assuming a market reference price of $3.50 and a protection amount of 65 gallons per month the following calculation would occur:

$3.50−$3.20*65=$19.50 credited back to the Consumer for that time period.

If the average market reference price is less than the protection price for a particular term, the Provider does not owe the Consumer a credit for that period of time but the Consumer still enjoys the benefits of the lower than anticipated retail fuel prices as well as the peace of mind that he or she will never pay more than a certain retail price in the future.

Although specific computer program code is not illustrated or described herein, it will be appreciated that a person who has ordinary skill in the field of computer programming and/or in the field of finance would be able to write a computer program in an appropriate computer program language to carry out the functions described herein.

What is claimed is:

1. A system for providing a plurality of users participating in an energy price protection plan with e-commerce and transaction capabilities, said system comprising:
a processor; and
a memory operatively connected to said processor, wherein said processor is operative with control instructions in said memory to perform the steps of:
receiving an account identifier associated with each user;
receiving, from each user, an anticipated geographic area associated with energy purchases;
storing said received anticipated geographic areas in association with each respective account identifier in said memory;
providing each user the calculated payment, wherein each respective payment is calculated by said processor based at least in part upon one of a first program price associated with each user and a second program price associated with each user as well as upon said market reference price, wherein the first program price for each user is independent of the first program price for each other user and the second program price for each user is independent of the second program price for each other user; and wherein each payment for each user is calculated by said processor based at least in part upon the first program price for that user when the geographic location of the automotive fuel purchase corresponds to said anticipated geographic area associated with energy purchases for that user and each payment for each user is calculated by said processor based at least in part upon the second program price for that user when the geographic location of the energy purchase does not correspond to said anticipated geographic area associated with energy purchases for that user.

2. The system of claim 1, wherein at least one of said first program price for each user and said second program price for each user is a capped price.

3. The system of claim 1, wherein at least one of said first program price for each user and said second program price for each user is based at least in part upon an effective time period, and a quantity, a grade and a brand of said energy; and said purchase information includes a date, a quantity, a grade and a brand of said energy.

4. The system of claim 1, wherein at least one of said first program price for each user and said second program price for each user is exclusive of taxes.

5. The system of claim 1, wherein said payment due to each of said users is provided as a credit to an account identified by a respective account identifier.

6. A method of providing quantitative value to a consumer in a consumer transaction, comprising providing energy price protection for a quantity of energy purchased over a time period, including providing payment to the consumer based on the difference between a first value of an established energy price and a second value related to the actual price of the energy quantity if the second value exceeds the first value.

7. The method of claim 6, wherein the second value is an average market reference price for the energy during the time period.

8. A method of providing energy price protection comprises guaranteeing each consumer that subscribes to an energy price protection monitoring system that the effective cost per unit of energy over a given time period will not exceed a predetermined price.

9. The method of claim 8, said guaranteeing comprising acquiring financial instruments to protect against rises in the cost per unit of energy over a given time period that is the same or different from the first mentioned given time period.

10. The method of claim 8, said guaranteeing comprising providing energy price protection to compensate for retail price increases above levels at the time of selling to the subscribing consumer.

11. A method of providing vehicle fuel-related price protection, comprising acquiring financial instruments to acquire a fuel product at future times, based at least in part on the cost to acquire such financial instruments, on the anticipated value of such financial instruments during a first prescribed time frame, and on the anticipated average price of vehicle fuel during a second time frame, determining a commercially valuable price at which to sell fuel price protection for a quantity of fuel to provide payment to a consumer, customer or their designee based on the difference between a first value of an established fuel price and a second value related to the actual price of the fuel quantity if the second value exceeds the first value.

12. The method of claim 11, wherein the actual value is average value.

13. The method of claim 11, wherein such financial instruments are purchase options.

14. The method of claim 11, wherein said acquiring financial instruments comprises acquiring options pertaining to at least one or more of gasoline, heating oil or other energy type.

15. The method of claim 11, said determining comprising investigating at least one of the factors of crude oil market supply, crude oil demand or crude oil price; investigating at least one of the factors of gasoline supply, gasoline demand or gasoline price, and determine hedges for compensating for fluctuations in the investigated factors.

16. The method of claim 11, said selling comprising selling fuel price protection to compensate for retail price increases above levels at the time of selling to the consumer, customer or designee.

17. The method of claim 11, said acquiring comprising acquiring financial instruments comprises acquiring at least one or more of options, futures or combinations.

18. The method of claim 17, comprising providing to a recipient of such price protection for a prescribed quantity of fuel a payment based at least in part on the average price of fuel over a prescribed time period, a guaranteed fuel price, and the prescribed quantity of fuel, provided that the average price of fuel over the prescribed time period exceeds the guaranteed fuel price during that prescribed time period without regard to whether the prescribed quantity of fuel was used by the recipient.

19. The method of claim 18, wherein the providing fuel price protection includes basing the fuel price protection on a wholesale price component of the fuel and/or a retail price component of the fuel.

20. The method of claim 19, wherein basing the fuel price protection on the wholesale price component includes basing the wholesale price component on prices set by an independent entity.

21. The method of claim 19, wherein basing the fuel price protection on the retail price component includes basing the retail price component on the fuel wholesale price component and market price for fuel.

22. The method of claim 18, wherein providing fuel price protection includes using at least one of fixed price protection, price increase protection, or buy down of price.

23. The method of claim 22, wherein using buy down of price includes implementing the buy down of price via a swap agreement and a put option.

24. The method of claim 22, wherein using price increase protection includes implementing a call option or swap.

25. The method of claim 18, wherein providing payment includes determining if the consumer meets at least one predetermined criteria and denying payment if the criteria is not satisfied.
